(19) United States
(12) Patent Application Publication
(10) Pub. No.: US 2007/0158478 A1
(43) Pub. Date: Jul. 12, 2007

(54) Method and apparatus for adjusting knife extension

(76) Inventor: Bradley R. Stager, Beaverton, OR (US)

Correspondence Address: Garth Janke;BIRDWELL & JANKE, LLP, Suite 1400, 1100 SW Sixth Avenue, Portland, OR, 97204, US

(21) Appl. No.: 11/329,921

(22) Filed: Jan. 10, 2006

(51) Int. Cl. B02C 17/02

(52) U.S. Cl. 241/91; 241/293

(57) ABSTRACT

A method and apparatus for adjusting knife extension. A knife assembly comprises a base and cover plate for clamping a knife therebetween. The cover plate attaches to the base and indexes the knife. An adjustment mechanism provides for adjusting the position of the cover plate relative to the base and defining an adjusted position of the knife relative to the base.

### FIELD OF THE INVENTION

The present invention relates to a method and apparatus for adjusting knife extension, particularly in a ring slicer for use in slicing or flaking logs, refuse lumber, chips, or other articles of wood in a lumber mill.

### BACKGROUND

Ring slicers, also termed ring flakers or stranders, are generally used for manufacturing particle board, oriented strand board, and fiberboard (e.g., MDF or “medium density fiberboard”). They convert logs, refuse lumber, chips, or other articles of wood into flakes, wafers or strands (hereinafter “flakes”) for the manufactured board products. The ring slicer includes a cylindrical ring assembly that rotates about the cylindrical axis. The ring assembly includes, typically, 49 to 72 parallel, elongate knife assemblies. The knife assemblies support respective elongate knives having cutting edges extending parallel to the axis of rotation of the assembly. The assembly rotates within a chamber into which pieces of wood to be cut or chipped are introduced, and are trapped for repeated encounters with the knives as the assembly spins.

FIG. 1 shows a representative prior art ring slicer 2. A cylindrical ring assembly 3 rotates about an axis “R.” Elongate knife assemblies 4 are shown in cross-section, seen in more detail in FIG. 2., The knife assemblies clamp respective knives 5 in place and each provides for an adjustable distance known as the “knife extension,” which is a distance that the cutting edge of the knife projects below the assembly to reach and cut an article of wood 6. The wood comes into contact with the knife 5 over the length of the extension as flakes 7 are cut from the wood. However, the cut flakes thereafter encounter a knife cover or clamping plate 8 of the knife assembly 4 that clamps the knife 5 to a base 9 of the knife assembly. In addition to clamping the knife, the cover plate 8 covers the knife, and so an outer surface 10 of the cover plate also serves to receive and guide the flakes away from the knife assembly in the manner of a counterknife.

FIG. 3 shows one of the knife assemblies 4 apart from the ring slicer, which has a cover plate 8, a base 9, and a knife 5 clamped between the cover plate and the base. FIG. 4 shows just the knife 5. The position of the cover plate relative to the base is fixed by a keying structure 12 (not visible, beneath the cover plate), e.g., keys inserted into corresponding key-ways in the cover plate and base. The position of the knife is held, for purposes of adjustment, by tightening relatively small adjustment bolts 14 extending into threaded holes 15 (FIG. 4) in the knife, movable within slots 16 of the cover plate. The position of the knife is fixed for use by tightening relatively large clamping bolts 18 extending through holes in the cover plate and into threaded holes in the base 9, movable within slots 22 (FIG. 4) of the knife.

The position of the knife is adjusted relative to the knife cover plate so that the knife extends outwardly from underneath the cover plate sufficiently far to provide the desired knife extension. The knife extension is an important parameter affecting the dimensions of the flakes cut by the ring slicer. As a result of knife wear, the knife is removed from its knife assembly, sharpened, and reinstalled in the assembly, so that knife assemblies must be repeatedly and frequently readjusted for knife extension.

A ring assembly may be either removable from the ring slicer or fixed within the ring slicer. In the former case it is referred to as a “removable ring” and in the latter case it is referred to as a “fixed ring.” Regardless of this distinction, however, the prior art strategy for adjusting knife extension is the same. The cover plate and knife portions of a knife assembly requiring adjustment are removed as a unit from the ring and mounted on an adjustment jig. FIG. 5 shows such a knife 4 and cover plate 8 in an adjustment jig 24. The adjustment bolts 14 are loosened. The cover plate is registered to the jig by use of keys 26 (not visible) extending from the jig and into the aforementioned key-ways in the cover plate. The knife 8 is pushed outwardly by air cylinders 28 until it hits stops 29 of the jig to set the knife extension. The knife and cover plate are temporarily held together in position by tightening the adjustment bolts 14. The knife and cover plate are thereafter removed from the jig as a unit and are tightly clamped together in the knife assembly by use of the clamping bolts 18.

The knife and cover plate are, in practice, carried from the ring assembly to the jig by hand. These parts are very heavy and therefore are difficult to carry, and carrying them safely also requires exceptional care since the knife remains somewhat sharp even when it has worn. Accordingly, there is a need for a method and apparatus for adjusting knife extension that reduces or eliminates the hazards in and difficulty of moving these parts from the ring slicer to the jig and back.

### SUMMARY

A method and apparatus for adjusting knife extension is disclosed herein. A knife assembly of a cutting apparatus comprises a base and cover plate for clamping a knife therebetween. The cover plate attaches to the base and indexes the knife. An adjustment mechanism provides for adjusting the position of the cover plate relative to the base and defining an adjusted position of the knife relative to the base.

A preferred method comprises adjusting a position of the second member relative to the first member to define an adjusted knife extension, and clamping the knife between the first and second members to fix the adjusted knife extension.

The method may be performed while the knife assembly is mounted in the apparatus. However, the method may be alternatively be performed on the knife assembly removed from the apparatus, using a separate fixture or jig.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a front, partially cut-away view of a-prior art ring slicer.

FIG. 2 is a view like FIG. 1, showing knife assemblies in more detail.

FIG. 3 is a pictorial view of one of the knife assemblies of FIG. 2.

FIG. 4 is an exploded view of the knife assembly of FIG. 3.

FIG. 5 is a pictorial view of knife and cover plate portions of the knife assembly of FIGS. 2-4 in a jig.

FIG. 6 is a pictorial view of a knife assembly according to the present invention for use in a ring slicer, particularly showing a cover plate, a base, and a knife clamped between the cover plate and the base.

FIG. 7 is a cross-section of the knife assembly of FIG. 6, taken along a line 7-7 thereof.

FIG. 8 is a view like FIG. 2, showing a number of the knife assemblies of FIG. 6 mounted to a ring.

FIG. 9 is a pictorial view of a back side of a preferred knife for use in the knife assembly of FIG. 6.

FIG. 10 is a pictorial view of a front side of the knife of FIG. 9.

FIG. 11 is an exploded view of the cover plate of FIG. 6 exploded from the base.

FIG. 12 is an exploded view of an adjustment device of the cover plate of FIG. 6 according to the present invention.

FIG. 13 is a pictorial view of an adjustment jig according to the present invention, for adjusting knife extension.

FIG. 14 is a pictorial view of the adjustment jig of FIG. 13 with the cover plate of FIG. 6 installed thereon for adjustment.

### DETAILED DESCRIPTION OF PREFERRED EMBODIMENTS

Reference will now be made in detail to specific preferred embodiments of the invention, examples of which are illustrated in the accompanying drawings. Wherever possible, the same reference numbers are used in the drawings and the description to refer to the same or like parts or dimensions.

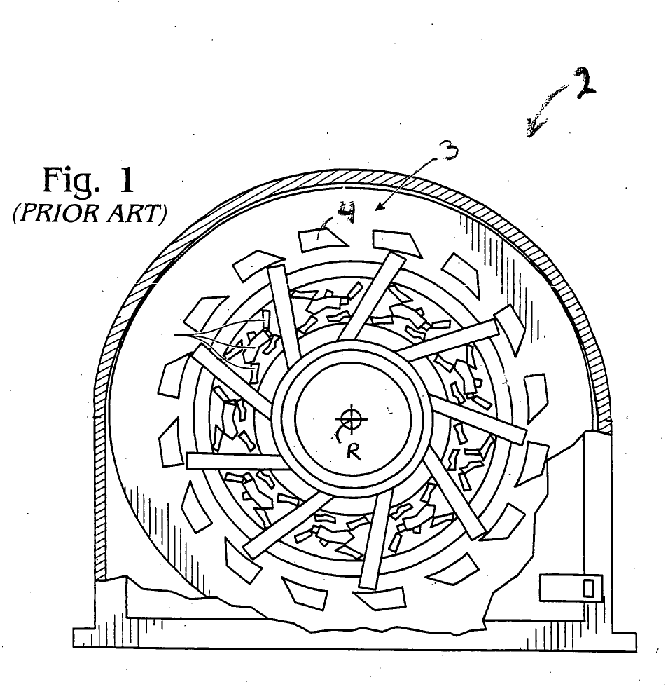

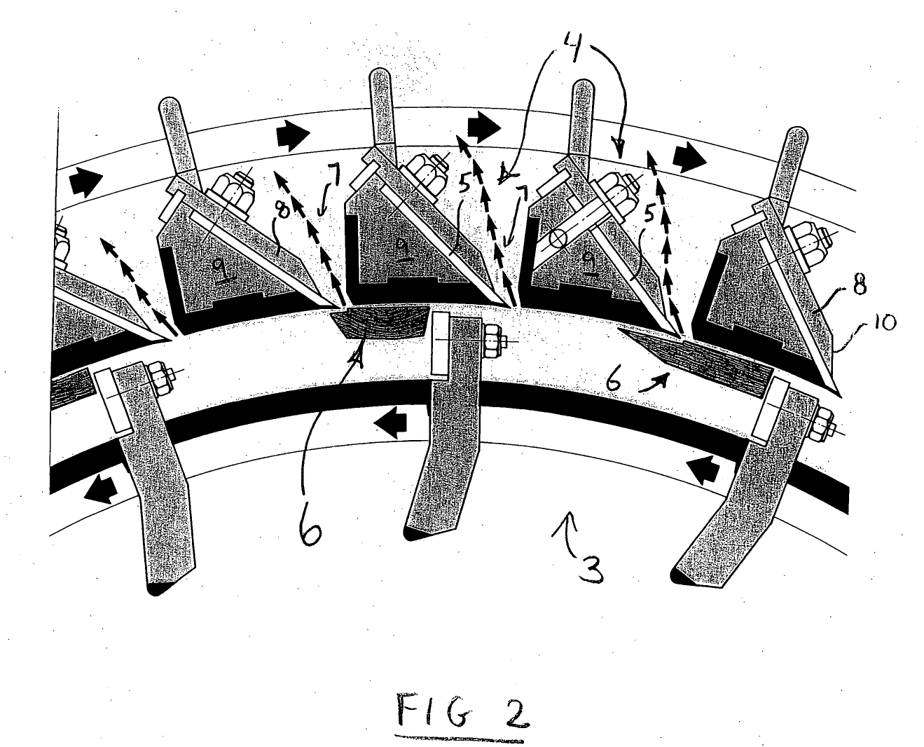

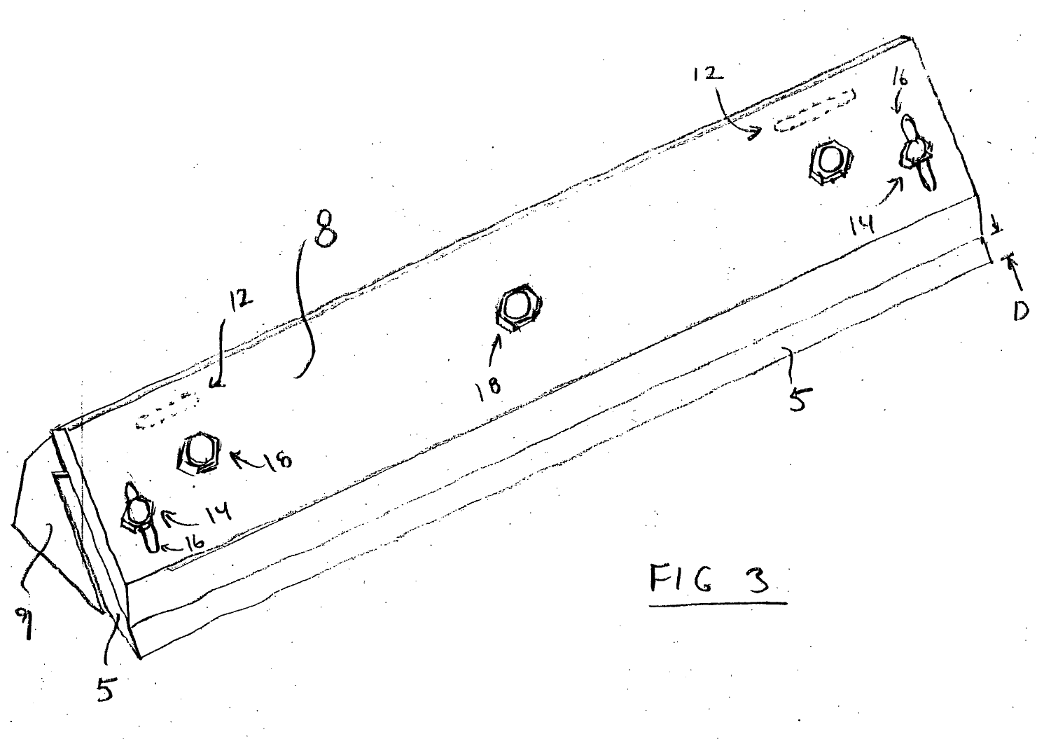

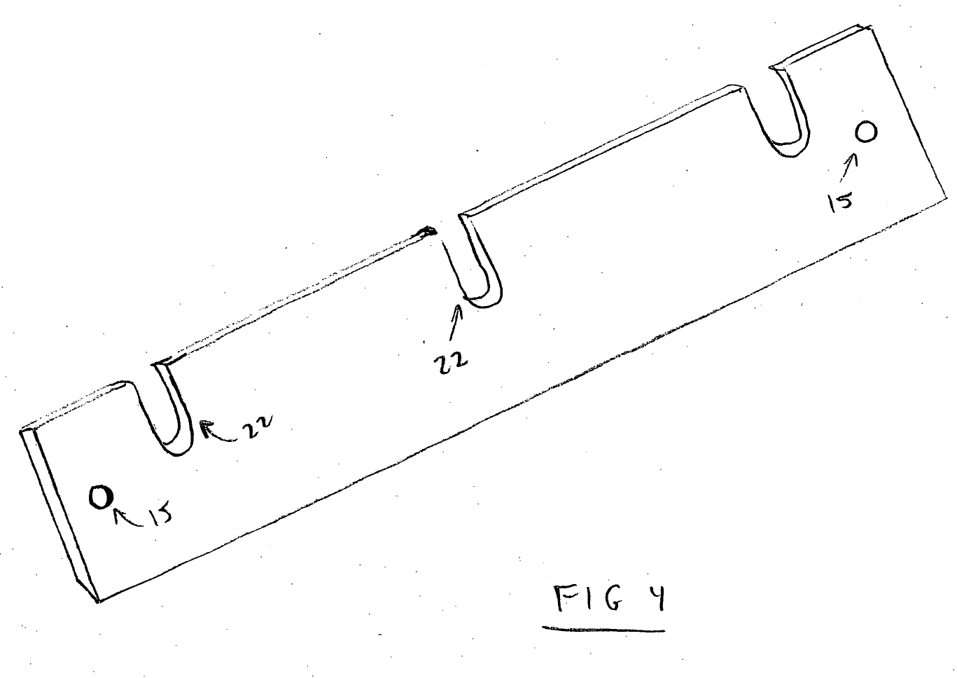

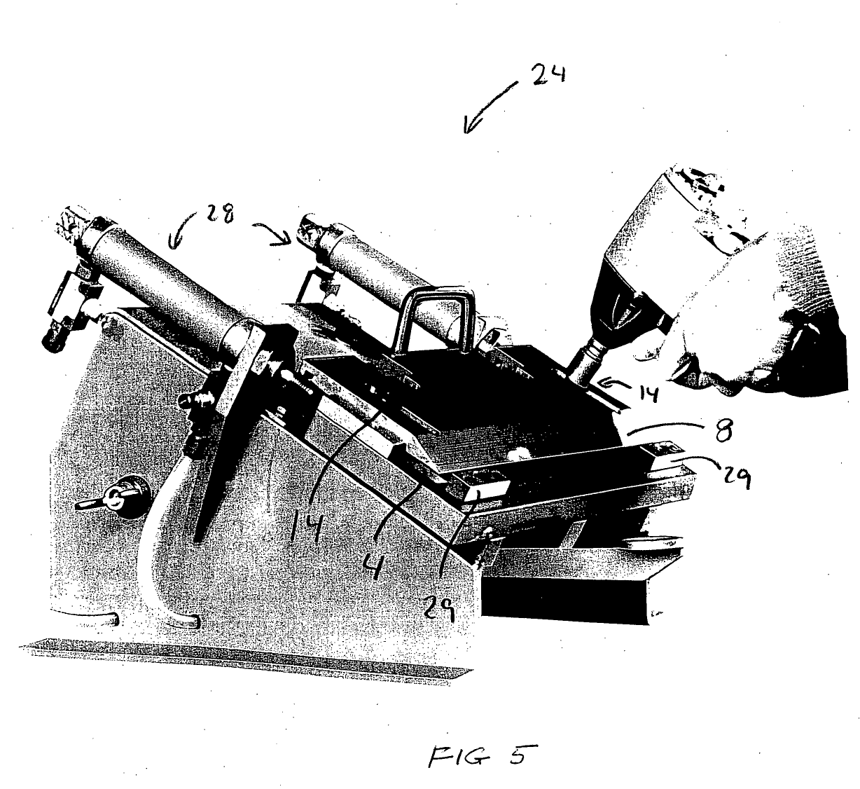

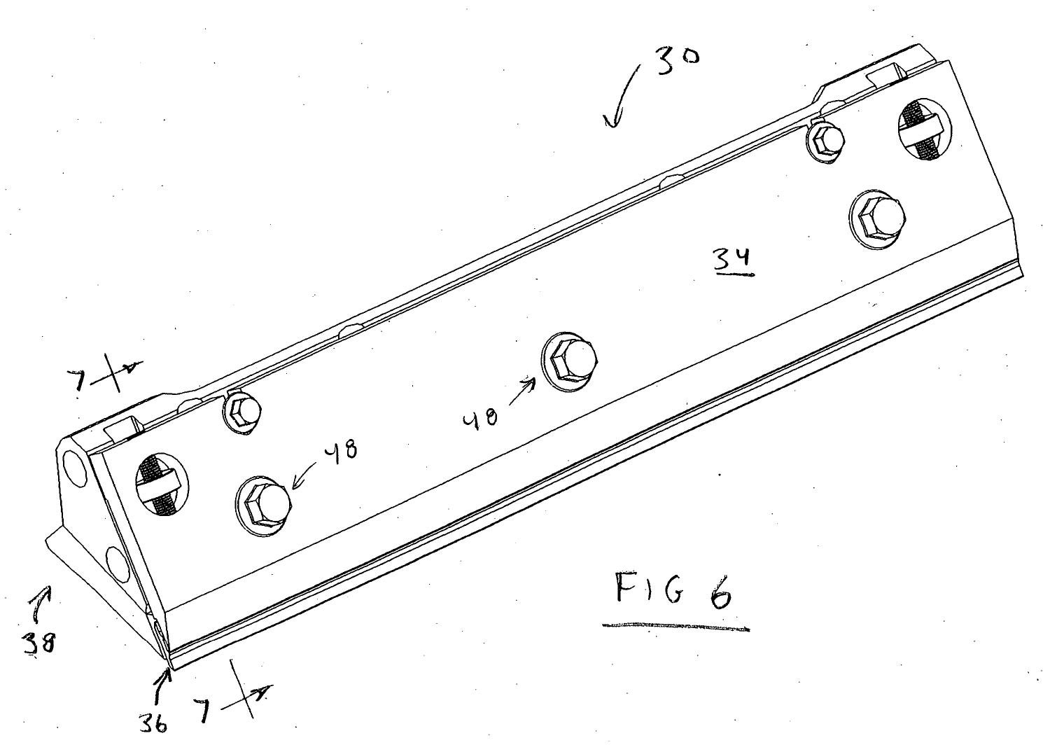

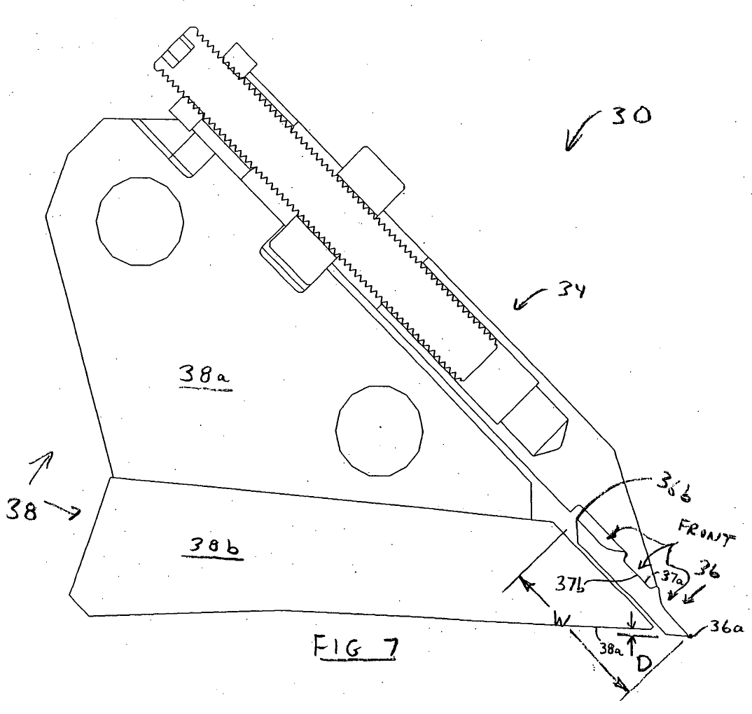

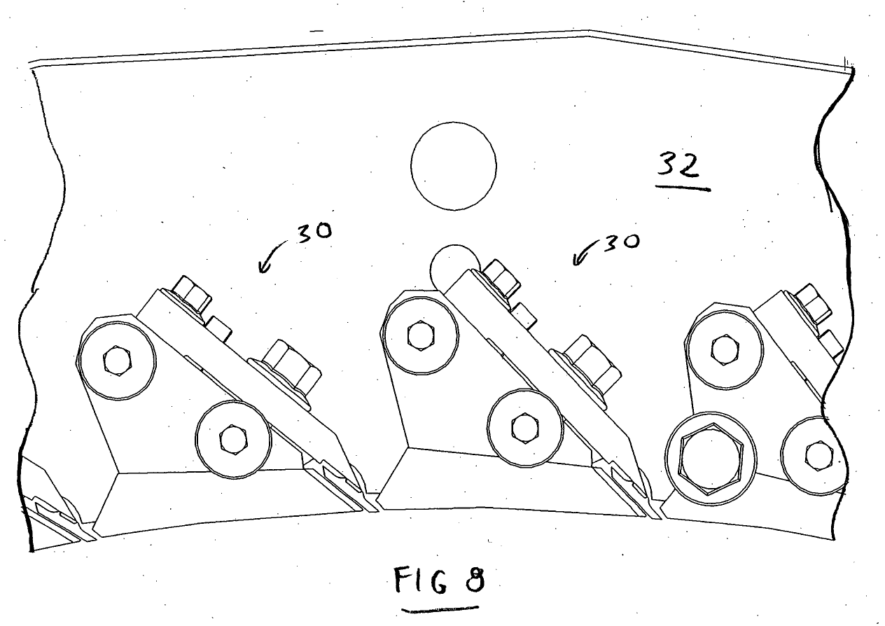

FIG. 6 shows, in pictorial view, a novel knife assembly 30 according to the present invention for use in a ring slicer. Apart from suitable adaptation for receipt of the knife assembly 30, the ring slicer may be and preferably is a typical, prior art ring slicer as otherwise shown in FIG. 1 and described above. FIG. 7 shows the knife assembly 30 in a cross-section, and FIG. 8 shows a number of the knife assemblies 30 mounted to a ring 32, the view being comparable to that of FIG. 2.

The knife assembly 30 includes a cover plate 34, a knife 36, and a base 38. The terms “cover plate” and “base” are intended to be general and are not limited to structures specific to ring slicers. As shown in FIG. 7, the knife extension (“D”) is defined between an exposed cutting edge 36a of the knife and a bottom edge 38a of the base. The invention provides for improvements in adjusting the knife extension.

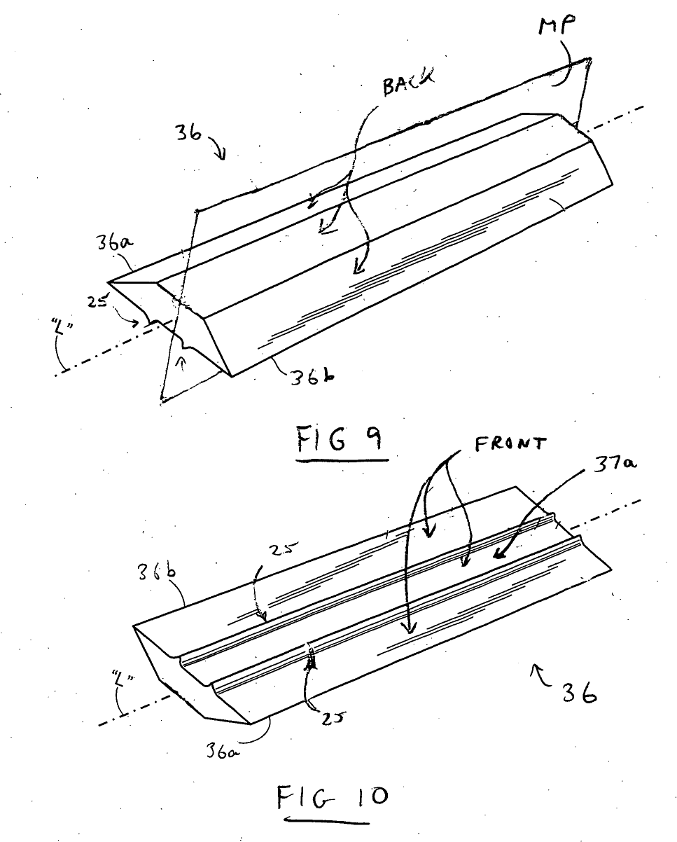

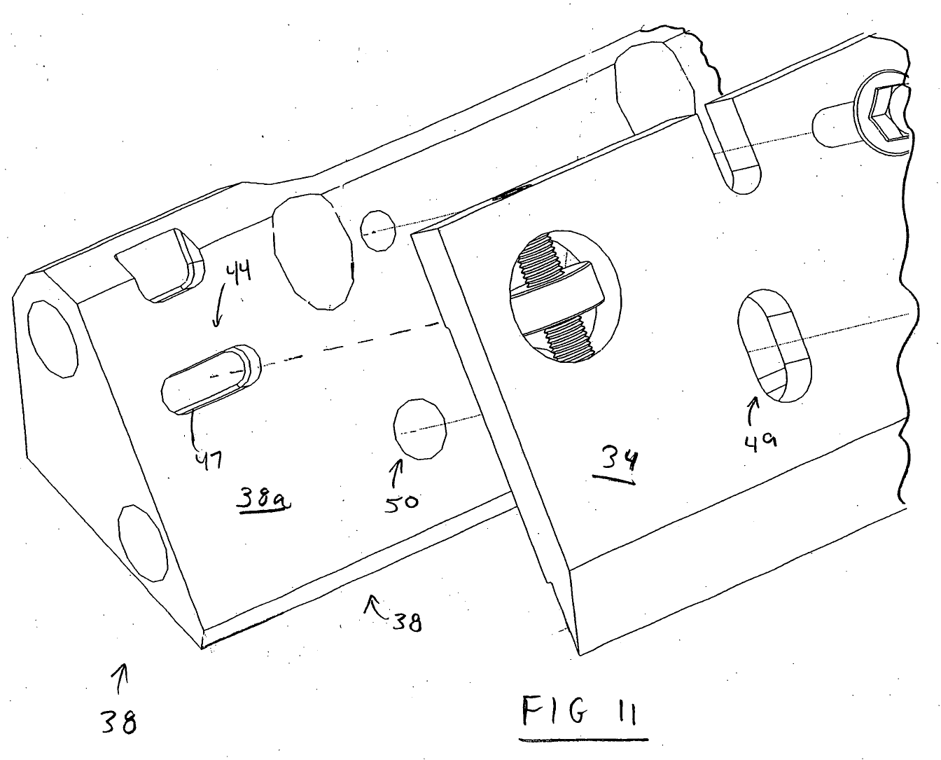

Preferably, the base is divided into two portions that are removably attached to each other, one which is referred to herein as an upper base portion 38a and the other referred to herein as a wearshoe 38b, though this division is not essential. The base and knife are preferably known types manufactured and marketed by Key Knife, Inc., of Tualatin, Oregon. The knife is particularly described in Schmatjen, U.S. Pat. No. 5,819,826, incorporated by reference herein in its entirety. FIGS. 9 and 10 show the back (“BACK”) and front (“FRONT”) sides of the preferred knife, respectively. A particularly advantageous feature of the preferred knife are that it is double-sided (parallel cutting edges 36a, 36b), so that when one cutting edge wears, it can be turned end-for-end to provide a fresh cutting edge. The cutting edges 36a and 36b are mirror images of one another with respect to a mirror plane “MP” passing through an elongate axis “L” of the knife.

With particular reference to FIG. 7, the knife 36 has a front (“FRONT”) side that faces the direction of rotation of the ring 32 (FIG. 8). The front side has a mating feature 37a, defined between two “deflector ridges” 25, that provides for mating contact indexing the knife to a complementary mating feature 37b of the cover plate 34. In the preferred knife as shown, the mating feature 37a is effectively a “recess” of the knife, so that the feature 37b is a corresponding projection of the cover plate. Because the knife is indexed to and moves with the cover plate 34, the knife extension can be adjusted, and set, by adjusting the position of the cover plate relative to the base, without the necessity of the knife being present.

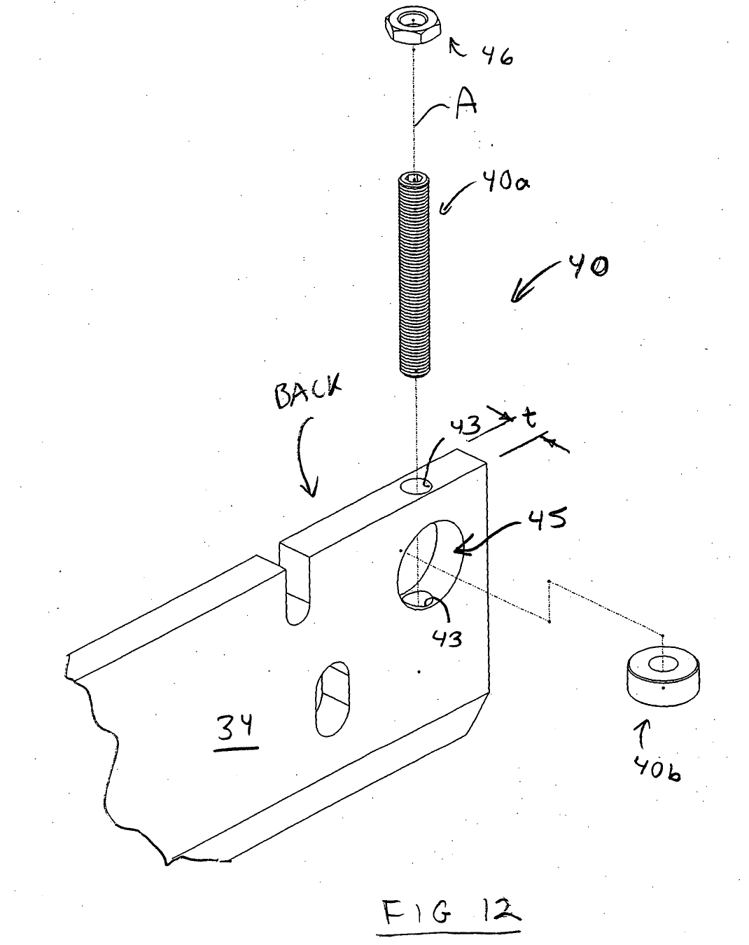

FIG. 11 shows the cover plate 34 exploded from the base 38, to show mounting relationships. Clamping bolts 48 (FIG. 7) extend through slots 49 in the cover plate and into threaded holes 50 in the base, particularly the upper portion 38a, to securely mount the cover plate to the base. It may be noted that the knife is securely held between the cover plate and the base by flexure of the cover plate acting as a cantilever; it is an advantage of the embodiment that the clamping bolts do not extend into or through the knife.

The cover plate also includes an adjustment device 40, a portion of which is received in a depression 47 of the base 38 serving a reference structure (generally indicated as 44). The adjustment device 40 cooperates with the reference structure 44 (together forming an embodiment of an “adjustment mechanism”) to provide for knife extension adjustment according to the invention as described below.

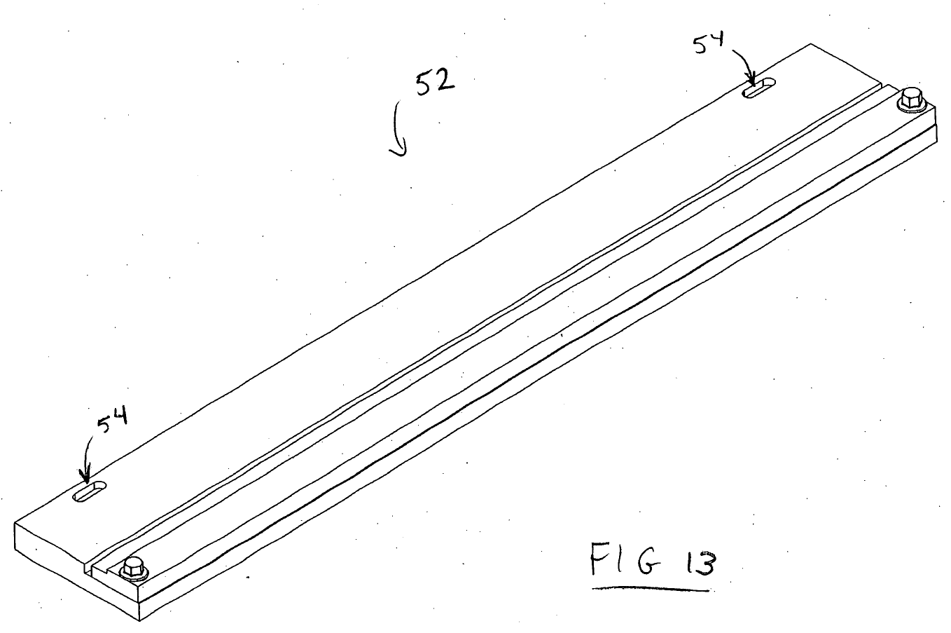

The preferred adjustment device 40 is shown exploded in FIG. 12 and is shown in cross-section in FIG. 7. The adjustment device comprises a set-screw 40a and a thumbwheel 40b that is, to a functional degree, fixedly attached to the threads of the set-screw 40a and which is used to turn the set-screw in a threaded hole 43 of the cover plate 34, where either of the two instances shown can be used alone or in combination with the other.

The thumbwheel 40b is within a volume 45 cut out of the cover plate. The volume 45 may be a simple cylindrical volume that is obtained simply by boring or drilling through the cover plate, though other volumetric forms could be provided. The volume 45 provides sufficient room for the thumbwheel 40b to move that the set-screw 40a may be threaded or unthreaded in the hole 43 over the full range of a desired knife extension adjustment without the thumbwheel coming into interference with the cover plate.

The thumbwheel 40b is turned by hand, which turns the set-screw 40a and thereby adjusts the axial position of the set-screw in the hole 43, which also moves the thumbwheel along the same axis, which is referenced as “A” in FIG. 12. Since the torque applied to the thumb-wheel is not large, the thumb-wheel may be fixedly attached to the set-screw by the use of an adhesive, such as that marketed under the trademark LOCTITE by Henkel Technologies, though any known fixing means may be used, e.g., welding, brazing, crimping, pinning, clamping, or utilizing another set-screw, as will be readily appreciated by persons of ordinary mechanical skill.

The diameter of the thumbwheel 40b is larger than the thickness “t” of the cover plate 34. Therefore, the thumbscrew projects beyond the back (“BACK”) side of the cover plate and is available for receipt in a suitably shaped and sized depression 47 (see FIG. 11) of the reference structure 44 of the base. The reference structure 44 snugly receives the thumbscrew to index the thumbscrew, and thereby index the cover plate, to the base. This indexing sets the knife extension, which can be locked for use simply by tightening clamping bolts 48. The knife extension may be temporarily locked, if desired (e.g., prior to final locking), by tightening a locking or jamb-nut 46 threaded on the set-screw 40a, so as to seat the jamb-nut against the cover plate.

Preferably, each end of the cover plate includes an instance of the adjustment device, so there are preferably at least two, such as shown in FIG. 6.

As is evident from the above, the thumbwheel 40b provides leverage for turning the set-screw 40a by hand and also indexes the cover plate to the base, as a result of a projecting portion thereof being received by the depression 47. It will be readily appreciated that the thumbwheel need not be cylindrical to provide these functions, and a thumbwheel for purposes herein may have other shapes and configurations as desired. For example, a thumbwheel may be star-shaped, or it may simply comprise a rod or T-handle extending radially from the set-screw.

An outstanding advantage of the invention is that a knife extension adjustment can be carried out without removing the knife assembly 30 from the ring 32 or the ring slicer. So it may be used in this manner in ring slicers that employ either fixed or removable rings, and is particularly advantageous for use in ring slicers having fixed rings. However, the invention may also be used in conjunction with an adjustment jig and in that context also provides an important advantage over the prior art.

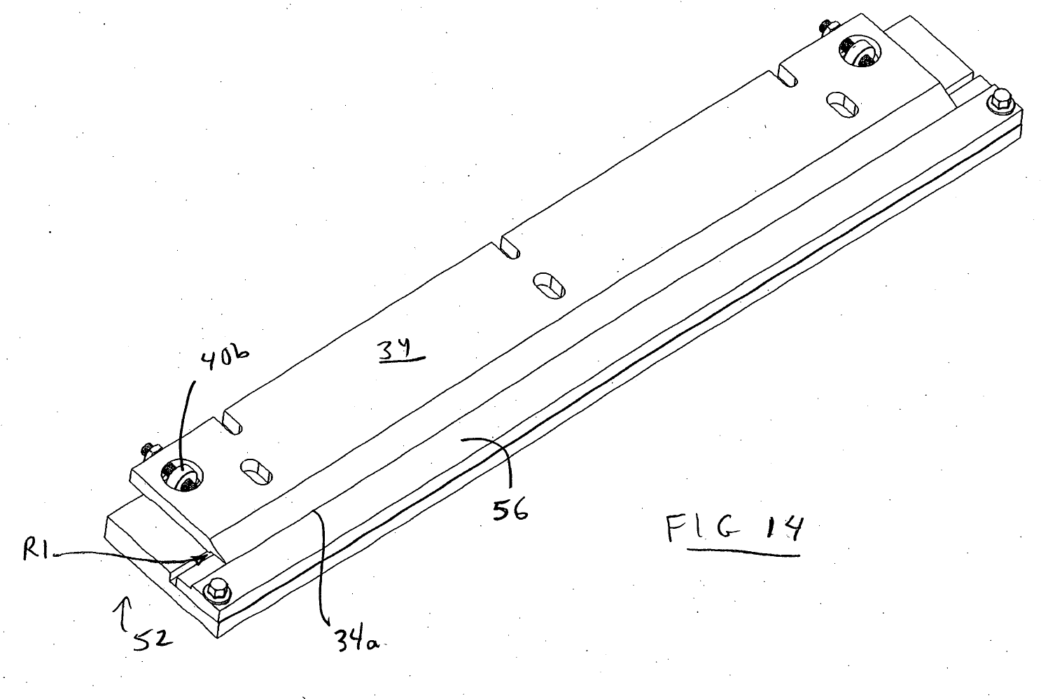

Particularly, turning to FIG. 13, an adjustment jig 52 according to the invention includes two depressions 54 mimicking the depressions 47 in the base 38, for receiving a corresponding thumbwheel 40b of each of two adjustment devices. The jig 52 thereby receives the cover plate 34 in an aligned relation to the base.

FIG. 14 shows the cover plate 34 installed in the jig 52. The cover plate has a terminal edge 34a that, when the knife 36 is indexed to the cover plate, is parallel to the cutting edge 36a of the knife. The thumbwheel 40b is received in the corresponding depression 54 and turned to move the cover plate forward until the terminal edge is stopped by one or more stops 56. In the embodiment shown, a single stop 56 is employed that runs the entire length of the jig, however, this is not essential. The jig 52, and particularly in this embodiment the stop(s) 56, is relieved in the region “R1” to receive the projection 37b (FIG. 7) such that the projection does not interfere with the adjustment. To avoid the risk of losing the adjustment during transport of the cover plate back to the ring or installation of the cover plate and knife into the knife assembly, it is advisable to temporarily lock the adjustment with the aforedescribed jamb-nut, preferably while the cover plate is in the jig.

While the invention obviates the need for using a jig, the procedure described above for use with a jig requires transporting only a cover plate, not a cover plate and a knife as in the prior art, providing another outstanding advantage. The safety concerns relating to the fact that the knife has a cutting edge are eliminated, and significantly less weight must be transported to and from the jig. It may also be noted that the preferred knife is considerably narrower (dimension “W” in FIG. 7) than many prior art ring slicer knives, and provides, in addition to the advantage of dual cutting edges, a significant weight reduction that facilitates handling and provides for savings in material cost.

It is to be understood that, while a specific method and apparatus for adjusting knife extension in a ring slicer has been shown and described as preferred, other configurations and methods could be utilized, in addition to those already mentioned, without departing from the principles of the invention. It should be understood that, while the preferred embodiment of the invention is adapted for use in a ring slicer used for producing flakes from logs, the invention may be employed in any cutting apparatus, for cutting wood or any other materials capable of being cut with knives.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A knife assembly for securing a knife to a rotating cutting apparatus, comprising:
a base for attachment to the cutting apparatus;
a cover plate for attachment to said base, clamping the knife between said cover plate and said base, and indexing the knife; and
an adjustment mechanism for adjusting the position of said cover plate relative to said base and defining an adjusted position of the knife relative to said base.

2. The knife assembly of claim 1, wherein said adjustment mechanism is adapted to substantially continuously adjust said position.

3. The knife assembly of claim 2, wherein said adjustment mechanism includes an elongate threaded member disposed in a threaded hole in said cover plate, the elongate axis of said threaded member being aligned with said axis, said position being adjustable by turning said threaded member.

4. The knife assembly of claim 3, wherein said adjustment mechanism includes a reference structure of said base, and a turning member attached to said threaded member and providing leverage for turning said threaded member by hand, said turning member adapted for indexing to said reference structure.

5. The knife assembly of claim 4, wherein said turning member is a thumbwheel projecting from said cover plate, and wherein said reference structure is a depression in said base adapted to receive a projecting portion of said thumbwheel.

6. The knife assembly of claim 5, wherein said cover plate has a mating feature for mating contact indexing the knife thereto.

7. The knife assembly of claim 1, wherein said cover plate has a mating feature for mating contact indexing the knife thereto.

8. The knife assembly of claim 1, including the knife.

9. The knife assembly of claim 8, wherein said knife has an elongate axis and two laterally spaced apart cutting edges parallel to said elongate axis.

10. The knife assembly of claim 9, wherein said adjustment mechanism is adapted to substantially continuously adjust said position.

11. The knife assembly of claim 10, wherein said adjustment mechanism includes an elongate threaded member disposed in a threaded hole in said cover plate, the elongate axis of said threaded member being aligned with said axis, said position being adjustable by turning said threaded member.

12. The knife assembly of claim 11, wherein said adjustment mechanism includes a reference structure of said base, and a turning member attached to said threaded member and providing leverage for turning said threaded member by hand, said turning member adapted for indexing to said reference structure.

13. The knife assembly of claim 12, wherein said turning member is a thumbwheel projecting from said cover plate, and wherein said reference structure is a depression in said base adapted to receive a projecting portion of said thumbwheel.

14. The knife assembly of claim 13, wherein said knife has a mating feature for mating contact with said cover plate indexing the knife thereto.

15. The knife assembly of claim 14, wherein said mating feature is effectively a recess in the front side of said knife, wherein said cover plate includes a projection for engaging said recess.

16. The knife assembly of claim 9, wherein said knife has a mating feature for mating contact with said cover plate indexing the knife thereto.

17. The knife assembly of claim 16, wherein said mating feature is effectively a recess in the front side of said knife, wherein said cover plate includes a projection for engaging said recess.

18. The knife assembly of claim 8, including the cutting apparatus, said cutting apparatus including two spaced apart annular rings for removably receiving the knife assembly therebetween.

19. The knife assembly of claim 18, wherein said knife has an elongate axis and two laterally spaced apart cutting edges parallel to said elongate axis.

20. The knife assembly of claim 19, wherein said adjustment mechanism is adapted to substantially continuously adjust said position.

21. The knife assembly of claim 20, wherein said adjustment mechanism includes an elongate threaded member disposed in a threaded hole in said cover plate, the elongate axis of said threaded member being aligned with said axis, said position being adjustable by turning said threaded member.

22. The knife assembly of claim 21, wherein said adjustment mechanism includes a reference structure of said base, and a turning member attached to said threaded member and providing leverage for turning said threaded member by hand, said turning member adapted for indexing to said reference structure.

23. The knife assembly of claim 22, wherein said turning member is a thumbwheel projecting from said cover plate, and wherein said reference structure is a depression in said base adapted to receive a projecting portion of said thumbwheel.

24. The knife assembly of claim 23, wherein said knife has a mating feature for mating contact with said cover plate indexing the knife thereto.

25. The knife assembly of claim 24, wherein said mating feature is effectively a recess in the front side of said knife, wherein said cover plate includes a projection for engaging said recess.

26. The knife assembly of claim 19, wherein said knife has a mating feature for mating contact with said cover plate indexing the knife thereto.

27. The knife assembly of claim 26, wherein said mating feature is effectively a recess in the front side of said knife, wherein said cover plate includes a projection for engaging said recess.

28. A method for knife extension adjustment in a cutting apparatus including a knife assembly comprising a base, a cover plate, and a knife, the knife assembly for mounting in the apparatus, clamping the knife between the base and cover plates, and indexing the knife to the cover plate, the method comprising the steps of:
(a) adjusting a position of the cover plate relative to a position of the base so as to define an adjusted knife extension; and
(b) clamping the knife between the base and cover plate after step (a) to fix the adjusted knife extension.

29. The method of claim 28, wherein steps (a) and (b) are performed while the knife assembly is mounted in the apparatus.

30. The method of claim 30, wherein said step of clamping fixes the adjusted knife extension by tightening clamping bolts extending through the cover plate and into the base, bypassing the knife.

31. The method of claim 28, further comprising removing the cover plate from the apparatus prior to step (a), wherein step (a) includes placing the cover plate on a jig adapted for receiving the cover plate in an aligned relation to the base, and re-installing the cover plate and the knife in the apparatus after step (a) and prior to step (b).

32. The method of claim 31, wherein said step of clamping fixes the adjusted knife extension by tightening clamping bolts extending through the cover plate and into the base, bypassing the knife.
